(19) United States
(12) Patent Application Publication
(10) Pub. No.: US 2026/0009445 A1
(43) Pub. Date: Jan. 8, 2026

(54) VIBRATION DAMPER PROTECTIVE TUBE

(71) Applicant: ZF FRIEDRICHSHAFEN AG, Friedrichshafen (DE)

(72) Inventors: Leon FURCHER, Braunschweig (DE); Thomas NOWOTKA, Bundorf (DE)

(21) Appl. No.: 19/256,387

(22) Filed: Jul. 1, 2025

(30) Foreign Application Priority Data
Jul. 3, 2024 (DE) 10 2024 206 252.9

(51) Int. Cl. F16F 9/38

(52) U.S. Cl. CPC F16F 9/38

(57) ABSTRACT

A vibration damper protective tube comprising a tubular body that surrounds an inner region to be shielded, for which purpose the body radially outwardly bounds the inner region in cross section with an inner contour. The body has, in cross section, two respective open ends that overlap one another at at least one separation location in that the one respective end is inserted to lie over the other respective end in circumferential direction and radially inwardly thereof, and which are displaceable relative to one another. Further, a respective degree of the respective overlapping of the two respective ends is adjustable during the displacement of the latter relative to one another and, therefore, a circumference of the inner contour can be changed.

### BACKGROUND OF THE INVENTION

### 1. Field of the Invention

The disclosure is directed to a vibration damper protective tube comprising a tubular body which surrounds an inner region to be shielded, for which purpose the body radially outwardly bounds the inner region in cross-section with an inner contour. The disclosure is further directed to a vibration damper with an above-mentioned vibration damper protective tube and to a method for producing a vibration damper protective tube.

### 2. Description of Related Art

In chasses of motor vehicles, vibration dampers are usually applied in the form of telescoping dampers, which are sometimes constructed as monotube dampers, but predominantly as two-tube dampers. Both in telescoping dampers constructed as monotube dampers and in telescoping dampers in the form of two-tube dampers, a piston is displaceably guided in a work cylinder, divides an interior space of the work cylinder into two work chambers and is connected to a piston rod. Further, the piston rod which is accordingly axially movable in the work cylinder is guided out of the work cylinder at one end and forms a fastening point of the respective telescoping damper at the end that is guided out.

Often, a protective tube is fastened to the end of the piston rod that is guided out. The protective tube surrounds the piston rod and also the work cylinder or a damper tube and protects the latter from mechanical damage and from an ingress of contaminants.

DE 10 2019 203 368 A1 shows a protective tube for a vibration damper. The protective tube has a tubular body. An inner region which is to be shielded is surrounded by the tubular body. The body is outfitted in cross section relative thereto with an invariable inner contour via which the inner region to be shielded is radially outwardly delimited.

### SUMMARY OF THE INVENTION

Proceeding from the above-described prior art, an object of one aspect of the present invention is to provide a protective tube for a vibration damper, which protective tube is to be universally suitable for application in different vibration dampers in a simple manner.

A vibration damper protective tube comprises a tubular body which surrounds an inner region to be shielded. To this end, the body radially outwardly bounds the inner region in cross section with an inner contour.

The vibration damper protective tube according to the invention is a protective tube which is provided explicitly for application in a vibration damper. The vibration damper protective tube in a vibration damper serves to shield components of the vibration damper located internal thereto, particularly a damper tube and an end of a piston rod that is guided out of the damper tube. The vibration damper protective tube is preferably fastened to the end of the piston rod, for which purpose the vibration damper protective tube is outfitted particularly with a fastening portion in addition to the tubular body. In this respect, the tubular body forms a further portion of the vibration damper protective tube in addition to this fastening portion.

The shielding of the components located inside of the vibration damper is effected in that an inner region in which the components to be shielded are located in the assembled state of the vibration damper protective tube is surrounded by the tubular body. For enclosing the inner region, the body is outfitted in cross section with an inner contour which radially outwardly surrounds, and therefore bounds, the inner region.

Within the meaning of the invention, “radial” means an orientation in diameter direction with a center point lying on a longitudinal center axis of the tubular body. On the other hand, “in circumferential direction” means a path along a respective circumference, particularly a circumference of the inner contour.

The body preferably has a substantially ring-like shape in cross section in that the tubular body, in cross section, is delimited by an outer contour in addition to the inner contour. In this regard, both the inner contour and outer contour can have an approximately circular shape in cross section, as a result of which the body also has an approximately annular shape in cross section.

According to one aspect the invention encompasses the technical teaching that the body has, in cross section, two respective open ends overlapping one another at at least one separation location in that the one respective end is inserted to lie over the other respective end in circumferential direction and radially inwardly thereof, and the two ends are displaceable with respect to one another. A degree of the respective overlapping of the two respective ends may be varied when the latter are displaced relative to one another and, therefore, a circumference of the inner contour may also be changed.

In other words, the body is split in cross section, i.e., at at least one separation location, so that two respective open ends are formed which overlap such that the one respective end, lying radially inwardly of the other respective end, is made to lie over the other respective end in circumferential direction. The two respective open ends are displaceable relative to one another. In the vibration damper protective tube according to one aspect of the invention, a respective degree of the respective overlap, i.e. the extent to which the two ends are made to overlap, can be changed during the displacement of the two ends relative to one another, which also results in a change in a circumference of the inner contour.

The advantage in a vibration damper protective tube configured in this way consists in that, as a result of the adjustability of the circumference of the inner contour, the vibration damper protective tube is universally suitable for application in different vibration dampers. This is because a change in the respective overlap by which the two respective ends of the at least one separation location are positioned with respect to one another also brings about a corresponding change in the circumference of the inner contour. As a result, the tubular body of the vibration damper protective tube according to the invention can easily be adapted to the inner region to be shielded and, therefore, also to an outer diameter of the components located therein by a corresponding change in the degree of overlap. The expenditure on production can be reduced as a result of the universal applicability.

It is key that the tubular body is split in cross section at at least one separation location, as a result of which two respective open ends are formed at this at least one separation location. The one respective end is moved past the other respective end radially inwardly thereof at the at least one separation location so that the two ends of the at least one separation location lie one another in circumferential direction and therefore overlap. As a result of the relative displacement of the two ends in circumferential direction with respect to one another, the overlapping may be varied and, therefore, the circumference of the inner contour may also be varied. This is because the circumference of the inner contour is reduced by increasing the overlap, while a reduction of the overlap results in an increase of the circumference of the inner contour.

According to an aspect of the invention, the two respective ends of the at least one separation location can be positioned with respect to one another in different discrete positions. Consequently, different fixed values of the degree of the respective overlap, and therefore also of the circumference of the inner contour, can be realized in the vibration damper protective tube according to the invention.

In a further development, a locking contour is formed in each instance at one of the respective ends of the at least one separation location, which locking contour protrudes in each instance radially in direction of the other end of the at least one separation location. The other end has, in each instance, a recess for each possible discrete position, which recess is oriented radially in direction of the one end of the at least one separation location and in which recess the respective one locking contour engages in the associated position, as a result of which the ends of the at least one separation location are prevented via positive engagement from moving apart in circumferential direction. Advantageously in this way, the discrete positions can be suitably defined on the one hand and an unwanted departure from an adjusted position of the respective two ends can be reliably prevented on the other hand.

According to an aspect of the invention, the two respective ends of the at least one separation location can be positioned with respect to one another in a continuous manner in a position range. Accordingly, in this case, the respective overlap of the two respective ends can be adjusted in a continuous manner within the producible position range and, therefore, a continuous adjustment of the circumference of the inner contour can also be realized.

When the body is outfitted in cross section with exactly one separation location, the positioning of the two ends of this separation location can be carried out either in discrete positions or in a continuous manner. Conversely, when the body has a plurality of separation locations, all of these separation locations could be configured with discrete positions, all of these separation locations could be configured in a continuous manner, or some of the separation locations could be configured with discrete positions and some of the separation locations could be configured in a continuous manner.

In an aspect of the invention, the body has exactly one separation location in cross section, and the body is formed by rolling a flat semifinished product to form the tubular shape. In so doing, the one end of the separation location is inserted by rolling to lie over the other end in circumferential direction and radially inwardly thereof, and the respective overlapping of the ends is produced in this way. Accordingly, the inventive adjustability of the circumference of the inner contour can be realized in a simple manner. Particularly preferably, the relative positioning of the two ends of the separation location is configured in a continuous manner.

According to an aspect for configuring the invention, the body has, in cross section, two separation locations and is formed by joining together two ring-segment-shaped portions. In each separation location, the one respective end is inserted to lie over the other respective end in circumferential direction and radially inwardly thereof, and the respective overlapping of the respective ends of the respective separation location is produced in this way. Also, a suitable construction for the adjustability of the circumference can be realized in this way.

Particularly preferably, the ends of the at least one separation location are fixed to one another with an adjusted degree of overlap for providing a determined circumference of the inner contour. In this way, it is ensured that the inner contour of the body maintains the adjusted circumference, and an unwanted widening or narrowing of the tubular body cannot occur particularly in the installed state of the vibration damper protective tube according to the invention in a vibration damper.

The above-mentioned fixing can be brought about in a frictionally engaging or positively engaging manner, but is particularly preferably realized in a bondingly engaging manner. Depending on the selection of a material of the tubular body, this can be realized by gluing or welding.

In a further aspect of the invention, the body comprises a plastics material or metal. In the former case, a low weight of the vibration damper protective tube according to the invention is accordingly possible, whereas in the latter case a high strength and good weldability results in particular.

A vibration damper protective tube in accordance with one or more of the variants described above is, in particular, part of a vibration damper which is preferably constructed as a telescoping vibration damper. In a vibration damper, the vibration damper protective tube according to the invention is then fastened particularly to one and of a piston rod by which the piston rod is guided out of a damper tube. The damper tube and the area of the piston rod that is guided out are then preferably located in the inner region shielded by the tubular body.

An aspect of the invention is a method for producing a vibration damper protective tube. In this regard, a tubular body is formed and an inner region to be shielded is surrounded, and a circumference of an inner contour bounding the inner region is defined in the body in cross section. For this purpose, two respective open ends which are displaceable relative to one another are positioned overlapping one another in each instance at at least one separation location of the body in that the one respective end is inserted to lie over the other respective end in circumferential direction and radially inwardly thereof. In this regard, a respective degree of the one respective overlap is adjusted for defining the circumference. In this way, a universally applicable vibration damper protective tube can be provided which can be precisely adapted to the case of application within the framework of the method by adjusting the one respective overlap in a reliable manner with the circumference of the inner contour.

In an aspect of the invention, the circumference of the inner contour is defined at exactly one separation location in that the body is brought to the tubular shape by rolling a flat semifinished product. During the rolling, the one end of the separation location is inserted to lie over the other end in circumferential direction and radially inwardly thereof and the overlap is adjusted in this way.

Alternatively, a variant of the invention consists in that the circumference of the inner contour is defined at two separation locations in that the body is formed by joining together two ring-segment-shaped portions, for which purpose the one respective end in each separation location is inserted to lie over the other respective end in circumferential direction and radially inwardly thereof, and the respective overlap is adjusted in this way.

In both of the cases mentioned above, the vibration damper protective tube according to the invention can be produced in a suitable manner and a desired circumference of the inner contour of the tubular body can be realized by adjusting the respective overlap.

In particular, the ends of the at least one separation location are fixed to one another with the one respective adjusted degree of the one respective overlap in order to maintain the respective adjusted degree. This fixing can be carried out in a frictionally engaging or positively engaging manner, but is preferably realized in a bondingly engaging manner, for example, by gluing or welding.

### BRIEF DESCRIPTION OF THE DRAWINGS

Advantageous embodiment forms of the invention described in the following are shown in the drawings. The drawings show:

FIG. 1 is a sectional view of a vibration damper with a vibration damper protective tube;

FIG. 2 is a sectional view of a vibration damper with the vibration damper protective tube according to the invention from FIG. 1;

FIG. 3 is a sectional view of a vibration damper with a vibration damper protective tube; and

FIG. 4 is a sectional view of a vibration damper with the vibration damper protective tube according to the invention from FIG. 3.

### DETAILED DESCRIPTION OF THE PRESENTLY PREFERRED EMBODIMENTS

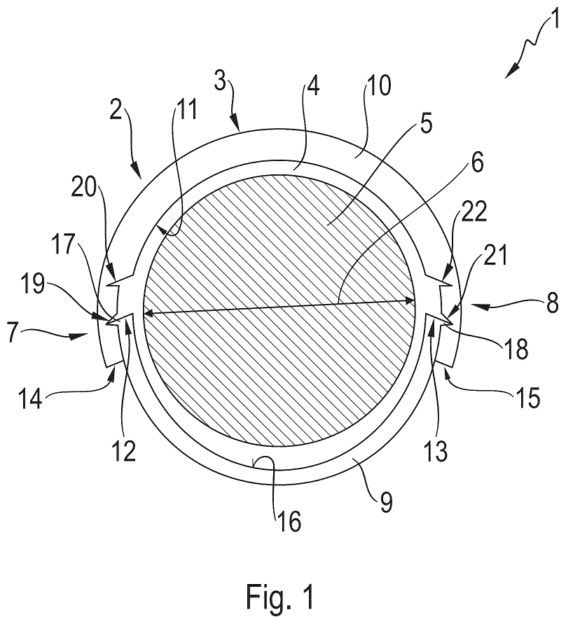

FIG. 1 shows a sectional view of a vibration damper 1 which is embodied in particular as a telescoping vibration damper. The vibration damper 1 comprises a vibration damper protective tube 2 which is formed in accordance with an aspect of the invention. The sectional view in FIG. 1 is shown as a cross section transverse to a longitudinal center axis of the vibration damper 1 and also of a tubular body 3 of the vibration damper protective tube 2.

In the present instance, the tubular body 3 surrounds an inner region 4 in which a component 5 of the vibration damper 1 to be shielded by the vibration damper protective tube 2 is placed in the depicted area. In particular, this component 5 is a damper tube of the vibration damper 1, and the component 5 has an outer diameter 6 in the present instance.

In the present instance, body 3 of vibration damper protective tube 2 is divided at two separation locations 7 and 8 into two ring-segment-shaped portions 9 and 10 which jointly form a ring-like cross section of body 3 and also define an inner contour 11 of the cross section of body 3 in addition to an outer contour. The inner region 4 is bounded radially outwardly by this inner contour 11.

The two portions 9 and 10 have open ends 12, 13, 14 and 15, respectively, at separation locations 7 and 8. Accordingly, the two portions 9 and 10 form body 3 in that, on the one hand, an overlapping of end 12 of portion 9 with end 14 of portion 10 is carried out at separation location 7, for which purpose end 12 of portion 9 is inserted radially inwardly of end 14 of portion 10 and, in so doing, is made to lie over end 14 in circumferential direction. On the other hand, an overlapping of end 13 of portion 9 with end 15 of portion 10 is also realized at separation location 8, for which purpose end 13 of portion 9 is inserted radially inwardly of end 15 of portion 10 such that the two ends 13 and 15 lie one over the other in circumferential direction.

The two ends 12, 14 and 13, 15, respectively, of portions 9 and 10 are displaceable relative to one another at the respective separation location 7 and 8, respectively. During the displacement, a respective degree of the respective overlap of the two ends 12, 14 and 13, 15, respectively, changes in circumferential direction. This also results in a change of a circumference 16 of the inner contour 11 in that an increase of the overlap at the respective separation location 7 and 8, respectively, causes a reduction of the circumference 16, and a reduction of the overlap at the respective separation location 7 and 8, respectively, causes an increase of the circumference 16.

As is apparent from FIG. 1, a respective positioning of the associated ends 12, 14 and 13, 15, respectively, relative to one another can be carried out in discrete positions at separation location 7 and at separation location 8, as a result of which determined values of the circumference 16 can also be realized. To this end, portion 9 is provided at its ends 12 and 13 in each instance with a locking contour 17 and 18, respectively, each of which locking contours 17, 18 projects outward in a hook-like manner relative to portion 9. Portion 10 is provided at its ends 14 and 15 in each instance with two recesses 19, 20 and 21, 22, respectively, which are formed on a radial inner side of portion 10. In the individual discrete position of the associated ends 12, 14 and 13, 15, respectively, relative to one another, the respective locking contour 17 and 18, respectively, engages in one of the two associated recesses 19, 20 and 21, 22, respectively. In this way, the two ends 12, 14 and 13, 15, respectively, are prevented in a positively engaging manner from moving apart in circumferential direction.

In order to adapt to the outer diameter 6 of the component 5 in the vibration damper 1 in FIG. 1, the discrete position of ends 12 and 14 relative to one another in which the locking contour 17 engages in recess 19 is realized with respect to separation location 7 on the one hand, and the discrete position of ends 13 and 15 relative to one another in which the locking contour 18 engages in recess 21 is realized with respect to separation location 8 on the other hand. Accordingly, an overlapping of the associated ends 12, 14 and 13, 15, respectively, which is as small as possible and, therefore, a value of the circumference 16 which is as large as possible are realized in both separation location 7 and separation location 8. In this state, the two portions 9 and 10 can further be bondingly fixed to one another, for example, by welding, at separation locations 7 and 8. The two portions 9 and 10 are preferably in the form of plastics parts.

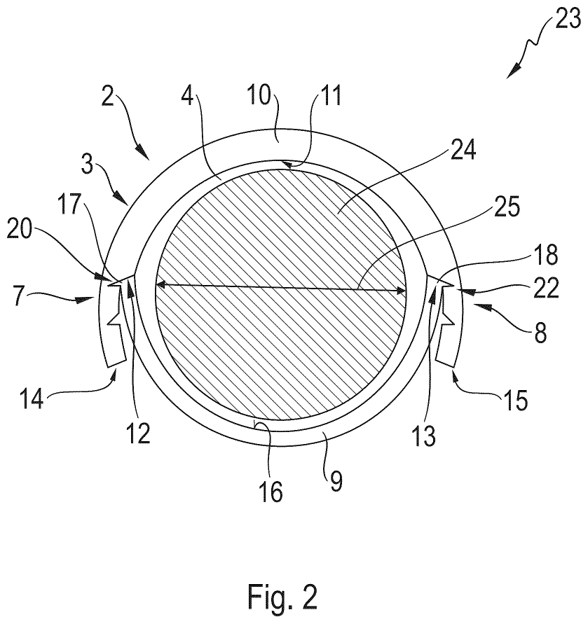

FIG. 2 shows the vibration damper protective tube 2 from FIG. 1 applied in a different vibration damper 23. In contrast to the vibration damper 1 from FIG. 1, a component 24 located in the inner region 4 of body 3 of vibration damper protective tube 2 has an outer diameter 25 which is smaller than the outer diameter 6 of component 5 of the vibration damper 1 from FIG. 1. In order to adapt the circumference 16 of the inner contour 11 to this smaller outer diameter 25, end 12 of portion 9 with locking contour 17 is brought into engagement at separation location 7 with recess 20 which is formed at end 14 of portion 10. Locking contour 18 of end 13 now also engages in recess 22 of end 15 at separation location 8 so that, taken together, in separation locations 7 and 8 the largest possible overlapping of ends 12, 14 and 13, 15, respectively, and therefore a smallest possible value of circumference 16 are realized. Here also, portions 9 and 10 can be bondingly fixed.

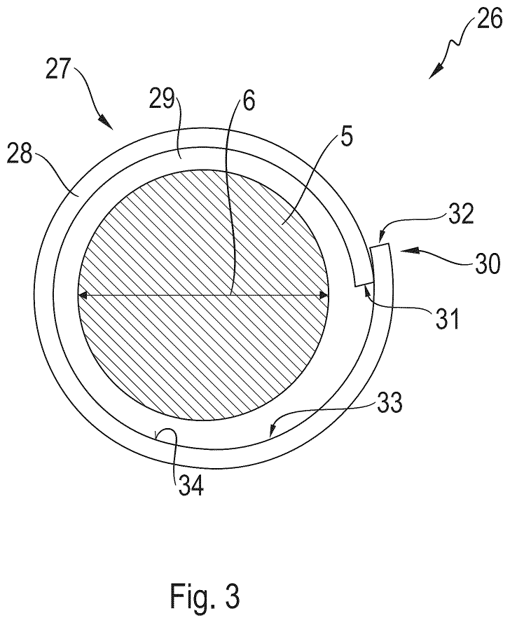

Further, FIG. 3 shows a sectional view of a vibration damper 26 which, like vibration damper 1 from FIG. 1, has a component 5 having outer diameter 6. However, in contrast to the variant according to FIG. 1, a vibration damper protective tube 27 provided in vibration damper 26 is formed corresponding to a second possible embodiment of the invention and is configured differently than the vibration damper protective tube 2 from FIGS. 1 and 2. While vibration damper protective tube 27 also has a tubular body 28 which surrounds the component 5 located in an inner region 29, this body 28 is formed in one piece.

Body 28 of vibration damper protective tube 27 is formed into the tubular shape by rolling a flat metal semifinished product so that there is a separation location 30 with open ends 31 and 32, and an inner contour 33 of body 28 is defined. The inner region 29 is bounded radially outwardly by this inner contour 33. At separation location 30, end 31 is inserted radially inwardly of end 32 and is placed over end 32 in circumferential direction resulting in an overlapping of ends 31 and 32. The two ends 31 and 32 are displaceable relative to one another and the overlapping of ends 31 and 32 changes during the displacement, which also results in a changed value of a circumference 34 of the inner contour 33. The overlapping of the two ends 31 and 32 can be changed in a continuous manner such that a value of the circumference 34 is also adjustable in a continuous manner.

In FIG. 3, a suitable overlapping of ends 31 and 32 of separation location 30 is selected with respect to the outer diameter 6 of component 5, as a result of which a suitable value for the circumference 34 is achieved. In particular, the two ends 31 and 32 are fixed to one another in this position at separation location 30, which is realized in particular by welding the two ends 31 and 32.

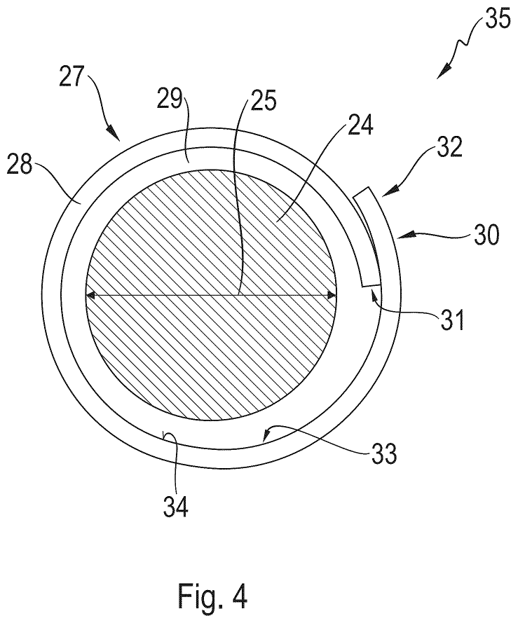

In contrast, the vibration damper protective tube 27 in FIG. 4 is applied in a vibration damper 35 in which a component 24 with an outer diameter 25 is located in the inner region 29 of body 28. This outer diameter 25 is smaller than outer diameter 6 of component 5 from FIG. 3 and, in order to adapt to this, the circumference 34 of the inner contour 33 in body 28 is selected smaller. This is achieved in that the two ends 31 and 32 have a larger overlap at separation location 30, which results in a smaller value of the circumference 34. In particular, the ends 31 and 32 are also fixed to one another in this position by welding.

A universally usable vibration damper protective tube can be realized by the inventive configurations.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A vibration damper protective tube comprising:
a tubular body which surrounds an inner region to be shielded, for which purpose the body radially outwardly bounds the inner region in cross section with an inner contour,
wherein the tubular body has, in cross section, two respective open ends which overlap one another at at least one separation location,
wherein one respective end is inserted to lie over an other respective end in circumferential direction and radially inwardly thereof, and which are displaceable relative to one another, and
a respective degree of the respective overlapping of the two respective ends is adjustable during displacement of the latter relative to one another and a circumference of the inner contour is changeable in this way.

2. The vibration damper protective tube according to claim 1, wherein the two respective ends of the at least one separation location are positionable with respect to one another in different discrete positions.

3. The vibration damper protective tube according to claim 2,
wherein a locking contour is formed in each instance at one of the respective ends of the at least one separation location, which locking contour protrudes in each instance radially in direction of the other end of the at least one separation location,
wherein the other end has, in each instance, a recess for each possible discrete position, which recess is oriented radially in direction of the one end of the at least one separation location and in which recess the respective one locking contour engages in the associated position, as a result of which the ends of the at least one separation location are prevented via positive engagement from moving apart in circumferential direction.

4. The vibration damper protective tube according to claim 1, wherein the two respective ends of the at least one separation location are positionable with respect to one another in a continuous manner in a position range.

5. The vibration damper protective tube according to claim 1,
wherein the body has exactly one separation location in cross section, wherein the body is formed by rolling a flat semifinished product to form a tubular shape, and
wherein the one end of the separation location is inserted by rolling to lie over the other end in circumferential direction and radially inwardly thereof, and the respective overlapping of the ends is produced in this way.

6. The vibration damper protective tube according to claim 1,
wherein the body has, in cross section, two separation locations and is formed by joining together two ring-segment-shaped portions,
wherein, in each separation location, the one respective end is inserted to lie over the other respective end in circumferential direction and radially inwardly thereof, and the respective overlapping of the respective ends of the respective separation location is produced in this way.

7. The vibration damper protective tube according to claim 1, wherein the ends of the at least one separation location are fixed to one another with an adjusted degree of overlap for providing a determined circumference of the inner contour.

8. The vibration damper protective tube according to claim 7, wherein the fixing is brought about in a bondingly engaging manner.

9. The vibration damper protective tube according to claim 1, wherein the body comprises a plastics material or metal.

10. A vibration damper, configured as a telescoping vibration damper, comprising:
a vibration damper protective tube, comprising:
a tubular body which surrounds an inner region to be shielded, for which purpose the body radially outwardly bounds the inner region in cross section with an inner contour,
wherein the tubular body has, in cross section, two respective open ends which overlap one another at at least one separation location,
wherein one respective end is inserted to lie over an other respective end in circumferential direction and radially inwardly thereof, and which are displaceable relative to one another, and
a respective degree of the respective overlapping of the two respective ends is adjustable during displacement of the latter relative to one another and a circumference of the inner contour is changeable in this way.

11. A method for producing a vibration damper protective tube, comprising:
forming a tubular body and an inner region to be shielded is surrounded, wherein a circumference of an inner contour bounding the inner region is defined in the body in cross section;
positioning two respective open ends, which are displaceable relative to one another, overlapping one another in each instance at at least one separation location of the body;
inserting one respective end to lie over an other respective end in circumferential direction and radially inwardly thereof, and
adjusting a respective degree of the one respective overlap for defining the circumference.

12. The method according to claim 11, wherein the circumference of the inner contour is defined at exactly one separation location in that the body is brought to a tubular shape by rolling a flat semifinished product, wherein, during the rolling, the one end of the separation location is inserted to lie over the other end in circumferential direction and radially inwardly thereof, and the overlap is adjusted in this way.

13. The method according to claim 11, wherein the circumference of the inner contour is defined at two separation locations in that the body is formed by joining together two ring-segment-shaped portions, for which purpose the one respective end in each separation location is inserted to lie over the other respective end in circumferential direction and radially inwardly thereof, and the respective overlap is adjusted in this way.

14. The method according to claim 11, wherein the ends of the at least one separation location are fixed to one another with the one respective adjusted degree of the one respective overlap.
